(19) United States
(12) Patent Application Publication
(10) Pub. No.: US 2015/0036454 A1
(43) Pub. Date: Feb. 5, 2015

(54) Paint Delivering, Metering And Mixing Device For Painting Guns

(71) Applicant: BASF Coatings GmbH, Münster (DE)

(72) Inventors: Joachim Vosskuhl, Ludinghausen (DE); Boris Peters, Munster (DE); Sibylle Schops, Munster (DE); Monika Tiggemann, Drensteinfurt (DE); Werner-Alfons Jung, Ascheberg (DE); Andreas Bauder, Mannheim (DE); Robert Engel, Speyer (DE); Wolfgang Haip, Hessheim (DE)

(73) Assignee: BASF Coatings GmbH, Münster (DE)

(21) Appl. No.: 14/371,126

(22) PCT Filed: Jan. 11, 2013
(86) PCT No.: PCT/EP2013/050511

§ 371 Date: Jul. 8, 2014

Related U.S. Application Data
(60) Provisional application No. 61/586,203, filed on Jan. 13, 2012.

(30) Foreign Application Priority Data
Jan. 13, 2012 (EP) 12151181.0

(51) Int. Cl. B01F 15/04; B01F 3/08

(52) U.S. Cl. CPC B01F 15/0479; B01F 3/088; B01F 2215/005
USPC 366/152.2

(57) ABSTRACT

Provided are devices for delivering, metering and mixing liquid paint components, comprising (a) a paint supplying device, which comprises two or more paint reservoirs or comprises one paint reservoir, having two or more chambers for different paint components, (b) a metering device, which is arranged downstream of the paint supplying device and comprises rotating delivery devices serving as metering units, the delivery devices each having a pair of wheels and being connected to one another by a common spindle in such a way that their rotational speeds are in fixed ratios in relation to one another, and (c) a static mixing device, which is arranged downstream of the metering device and the outlet of which may be connected to a paint spray gun. Also provided are methods for using the device and for coating a substrate using the device in combination with a paint spray gun.

The present invention relates to a combined paint delivering, paint metering and paint mixing device for painting guns and to a spray-painting method using such a paint delivering device.

Spray-painting methods without electrostatic charging of the paint are widely used in industrial and commercial paint shops. The methods are especially distinguished in comparison with other painting methods in that they can be used manually, have a high degree of flexibility with respect to the shape, size and materials of the objects painted and with respect to the choice of paint and changing of the paint, are mobile in their use and entail relatively low investment costs (H. Kittel, “Lehrbuch der Lacke and Beschichtungen” [textbook of paints and coatings], second edition, volume 9, pages 26-40; S. Hirzel Verlag Stuttgart and Leipzig, 2004).

The spray-painting methods can be divided essentially into compressed-air spraying by a high-pressure or low-pressure method and airless spraying without or with air assistance.

Pneumatic atomization or compressed-air spraying was developed as the first spray-painting method around 1900. Even today, compressed-air atomization is used most frequently in industry and commerce. In the case of high-pressure spraying, also referred to as conventional spraying or pneumatic spraying, an air pressure of approximately 2 to 7 bar is usually used, while in the case of low-pressure spraying, also referred to as HVLP spraying (“High Volume, Low Pressure” spraying or spraying with a high spray volume flow and low pressure), an air pressure of 0.2 to 0.7 bar is usually used (H. Kittel, ibidem).

At the atomizer head, the compressed air flows out of an annular orifice, which is formed by a central bore in the air cap and the paint nozzle arranged therein. Further air jets from various air cap bores serve for regulating the shape of the jet and for assisting the atomization. The compressed air flowing out at high speed causes there to form directly at the paint nozzle tip a low-pressure zone, which, by having a sucking effect, assists the outflow of paint from a so-called suction cup, especially when the paint is supplied in a pressureless state (H. Kittel, ibidem).

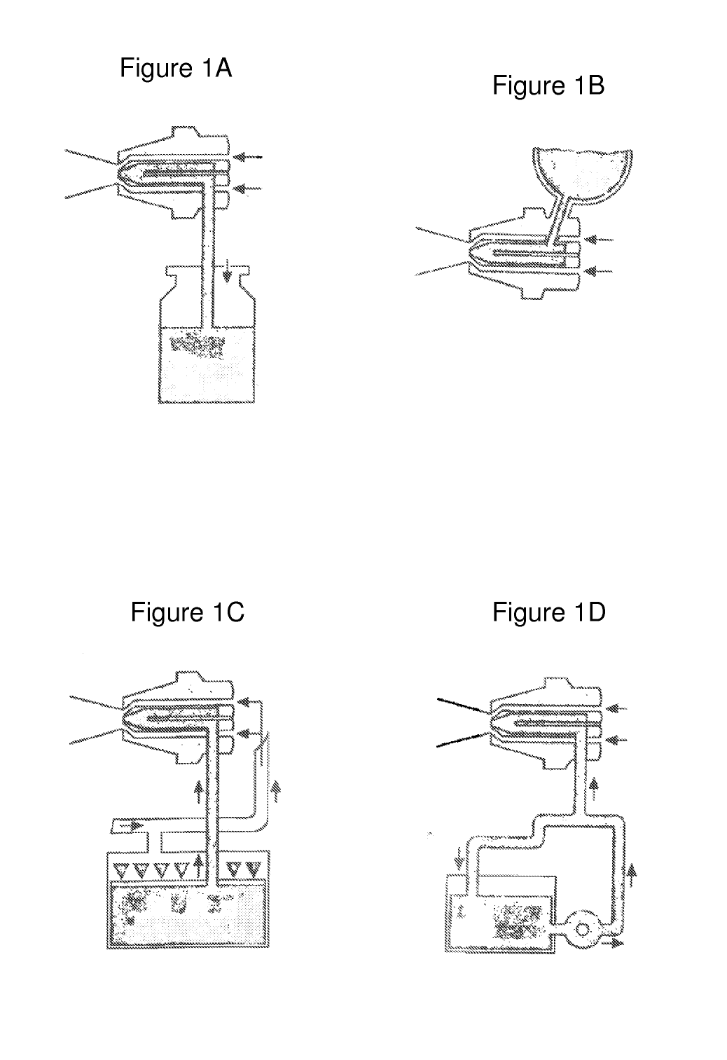

Apart from delivering the paint material from a suction cup, there is also the possibility, depending on the amount required and the viscosity, of supplying the paint material by delivery systems such as gravity cups, pressure vessels or circulating-air systems of the paint spray nozzle (FIGS. 1A-D). In FIG. 1A, the supply of paint is represented by means of a suction cup system; as explained above, it takes place through the suction effect of the spraying air. Typical cup capacities are volumes of up to approximately 1 liter. FIG. 1B illustrates a gravity cup system, the supply of paint taking place both through the suction effect of the spraying air and with the assistance of the hydrostatic pressure of the paint. Also in the case of this paint delivery system, cup volumes of approximately 1 liter are usually not exceeded. The pressure system (FIG. 1C) and the circulating system (FIG. 1D) are less suitable as paint delivery systems for mobile use. In the case of the pressure system, the supply of paint takes place from a pressurized tank with the assistance of pressure from 0.5 to 4 bar (usual tank capacity 1 to 250 liters). In the case of the circulating system, the supply of paint takes place by way of piston or turbine pumps, it only being appropriate to use the circulating system where there is a daily paint consumption of over 100 liters (H. Kittel, ibidem).

In particular in low-pressure spraying, the suction effect caused by the negative pressure at the paint nozzle tip of a so-called HVLP spray gun is less than in the case of high-pressure spraying, for which reason assistance of the suction effect caused by the hydrostatic pressure of the paint is desired specifically in the low-pressure range. It is therefore recommendable when processing small amounts of paint with low-pressure spraying to work with a gravity cup system as the paint delivery system.

On account of their limited processing time (pot life), two-component coating agents (2-component coating agents) are usually processed by the spraying method. In this case, the metering of the base paint and the hardener represents the central problem. In the case of small series and individual parts, and in particular also the repair paint sector, for example the auto repair paint sector, the 2-component material is generally manually mixed in the prescribed ratio and sprayed like a one-component material. This means in practice that both the metering and the mixing of the components take place before the filling of a gravity cup or suction cup, or in the gravity cup or suction cup itself, and consequently the quality and homogeneity of the mixture also depend greatly on the manual skills of the painter. Unused material must be thrown away once the pot life has expired. On the other hand, quick drying and hardening characteristics of the paint film are desired, for which reason hardening catalysts are often incorporated in the base paint and/or hardener of the 2-component or multi-component mixture.

Therefore, specifically when using 2-component or multi-component coating agents, there is the desire for a long processing time or pot life, with however at the same time improved drying and rapid development of hardness of the sprayed-on paint film.

In order to obtain the best possible appearance of the hardened paint film and reproducible qualities, it is absolutely necessary to prepare consistently high-quality compositions of base paint and hardener that are as homogeneous as possible and have consistent properties over the entire application time. Specifically in the case of premixed 2-component systems, this is not always the case, if for example a short pot life has the effect that the material that is sprayed first has a low viscosity on account of a not yet advanced reaction of the constituents, while the material remains that are sprayed later already partially contain viscosity-increasing cross-linking products.

For the production of large numbers, with short pot lives and high quality requirements, highly specialized metering and mixing installations are used in industry, in order to maintain tolerance limits for the metering accuracy of +/−5% hardener volume with respect to the amount of base paint. Further developments are aimed at pulsation-free metering and low installation wear, for example by the use of membrane metering devices. Static or dynamic systems with driven mixing units are used for the mixing. In the case of very short pot lives, special guns in which the base paint and the hardener are discharged from separate nozzles and the droplets produced mix together in the spray jet are also used (H. Kittel, ibidem).

Specifically in small paint shops, however, there is the demand for much less sophisticated delivering, metering and mixing devices. In particular, it should not be necessary to use the previously mentioned special guns or highly specialized metering and mixing units. The simplicity of the use of suction cups or gravity cups, in particular the latter, should be retained. Delivery, metering and mixing should take place just by way of the hydrostatic pressure of the paint, the suction effect of the negative pressure produced by the spraying of the paint and a pressure that is possibly applied to the gravity cup. Further external driving of the delivery, metering or mixing should not be required. In particular, driving by pumps and the like should not be necessary. Nevertheless, a processability that is virtually independent of the pot life should still be ensured, with at the same time homogeneous mixing of the components before they reach the nozzle of the spray gun, preferably the spray gun itself. The paint films obtained should have good drying and rapid development of hardness and leads to hardened films with a good appearance.

WO 93/13872 A1 describes a method for applying a multi-component repair paint coating composition in which at least two paint components are kept in separate containers and at least one component is applied under pressure to a kinetic metering installation, which comprises two double-acting cylinders with cylinder rods attached to pistons. The metered components are supplied to a mixer, which opens out into a paint spray gun. The structure of the metering device is rather complex and absolutely needs the application of compressed air to at least one paint reservoir.

The aforementioned objects have been achieved by the inventors of the present invention in a surprising way by providing a special device for delivering, metering and mixing liquid paint components that does not have the disadvantages of the prior art.

The device according to the invention has the following device units:
(a) a paint supplying device, which
   i. comprises two or more paint reservoirs with in each case at least one outlet opening for different paint components to be mixed with one another; or
   ii. comprises one paint reservoir, which comprises two or more chambers for different paint components to be mixed with one another, each chamber having at least one outlet opening,
(b) a metering device, which is arranged downstream of the paint supplying device and has a number of inlet openings for the paint components corresponding to the number of outlet openings of the paint reservoirs or the paint reservoir, the metering device being designed such that the volume flows of the paint components to be mixed with one another entering via the inlet openings are forcibly delivered separately from one another by way of rotating delivery devices serving as metering units, the delivery devices being connected to one another in such a way that their rotational speeds are in fixed ratios in relation to one another, and the metering device having separate outlet openings for the then metered volume flows of the paint components, and
(c) a static mixing device, which is arranged downstream of the metering device and has a number of inlet openings for the metered volume flows corresponding to the number of outlet openings of the metering device, and the outlet of which is formed in such a way that it can be connected to a paint spray gun.

The term paint reservoir comprises, inter alia, embodiments such as for example cups, preferably gravity cups, disposable cartridges or bags and the like.

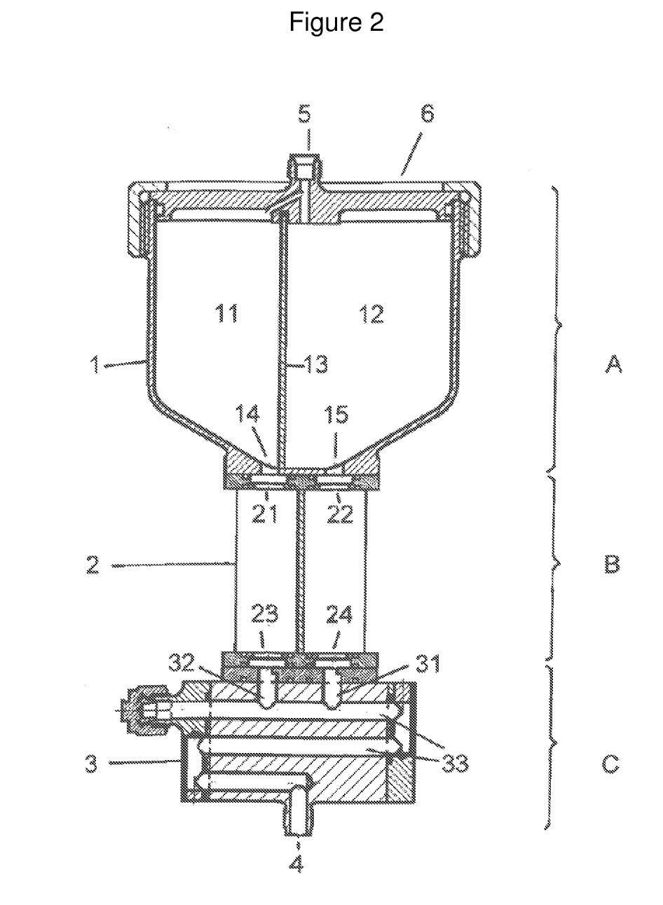

If the paint reservoir has two or more chambers, these chambers may have any desired form and be arranged as desired in relation to one another. For example, the chambers in a paint reservoir in the form of a cup may be separated from one another simply by a separating wall in the form of a panel (see for example FIG. 2). However, a concentric arrangement of the chambers is also possible. In the latter case, the paint component of the inner chamber must then be delivered by means of a kind of injector outlet through the wall of the outer chamber, so that separate outlet openings for the paint components are retained, and consequently separate metering is made possible. Such a concentric arrangement makes it possible for the paint supplying device to be screwed more easily to the paint metering device.

The device unit (a) preferably comprises i. two paint reservoirs for two different paint components or ii. one paint reservoir with two separate chambers for two different paint components, in particular in case i. one paint reservoir for a base paint and a second paint reservoir for a hardener or in case ii. one paint reservoir with a first chamber for a base paint and a second chamber for a hardener. In the latter embodiment, the paint reservoir has two outlet openings, one each for the base paint and for the hardener. In the case of this embodiment, the metering device correspondingly has two inlet openings, one each for the base paint and for the hardener, and two outlet openings for the metered volume flows.

It applies to all the embodiments that the volume flows of the components, such as for example of the base paint and the hardener, are respectively supplied to a rotating delivery device separately from one another. In one particular embodiment, each individual rotating delivery device is designed such that it consists of two wheels engaging in one another. Consequently, an individual rotating delivery device, comprising a pair of wheels, respectively exists for each volume flow. The interengaging wheels of the pair of wheels are preferably gear wheels, which may be of an either circular or oval design, or bucket wheels. Particularly preferably, they are pairs of oval wheels. The wheels of the individual delivery devices are connected to one another in such a way that their rotational speeds are in fixed ratios in relation to one another. This takes place, for example, by fastening at least one of the two interengaging wheels of one delivery device respectively to one of the two wheels of the other delivery devices respectively on one and the same shaft or spindle. The interconnected wheels of the delivery devices consequently act dependently on one another in a synchronized manner, while the second wheel in each case of the respective pair of wheels may be freely mounted, since it is taken along, that is to say driven, by way of the first synchronized wheel. This type of driving is referred to as forced delivery and is essential to compensate for the usually existing differences in viscosity of the different components. The pairs of wheels are designed with respect to their size such that the volume flows respectively to be metered are delivered by them. The spatial separation of the pairs of wheels may be realized, for example, by separating walls in the metering device. The separation of the volume flows prevents premature mixing of the different components in the delivery devices.

A further possibility for forced delivery can be realized, for example, by using bucket wheels. In such a case, it is not absolutely necessary to use two pairs of wheels. Each volume flow can, for example, be delivered here by way of only one bucket wheel, the bucket wheels of the delivery devices being connected to one another in such a way that their rotational speeds are in fixed ratios in relation to one another. This too can take place by way of a common synchronizing spindle or shaft. The required volumes can, for example, be metered here by way of the capacity of the buckets of the bucket wheels.

If the hydrostatic pressure of the paint in the paint reservoirs or in the paint reservoir and the suction effect of the spray gun are not sufficient on their own to set the pairs of wheels in motion or keep them in motion, compressed air may be applied to the paint reservoir. In such a case, the paint reservoir is, for example, closed with a pressure-tight cover, which has a compressed-air inlet opening via which compressed air can be applied. External driving of the pairs of wheels is neither provided nor desired.

To this extent, the metering device is a completely closed unit and is only connected to the paint reservoirs or the paint reservoir via the inlet openings and to the static mixer via the outlet opening(s). This structural design of the metering device is low-maintenance and energy-efficient.

If the delivery of the paint components takes place just by way of the hydrostatic pressure of the paint and the suction effect of the spray gun, the paint reservoirs or the paint reservoir may be closed with a ventilated cover. In a preferred embodiment, however, the delivery of the paint takes place by additionally applying compressed air to the paint components, these being forced out of the paint reservoirs or the paint reservoir into the metering device by the compressed air. In such a case, the paint reservoirs or the paint reservoir are or is a completely closed unit that only has at least one inlet opening for compressed air and the outlet openings to the metering device.

The same also applies to the mixing device, which likewise represents a completely closed unit that is only connected to the metering device via the inlet openings and to the spray gun via the outlet opening. Connected to one another may also mean that the mixing device is partially/entirely integrated in the body of the spray gun.

The three device units (paint supplying device, metering device, static mixing device) may, for example, be connected to one another by way of pressure-tight threads or welded or adhesively bonded to one another. In order to ensure seal-tight terminations in the case of screwed joints, sealing rings and the like are used, for example, as is known to a person of average skill in the art.

FIG. 2 describes the basic structure of one particular embodiment of the invention for the use of a 2-component system using two different paint components. The particular embodiment of a device according to the invention for delivering, metering and mixing liquid paint components that is represented in FIG. 2 comprises a paint supplying device (A), which comprises one paint reservoir (1), which in turn comprises two chambers (11 and 12), separated by a separating wall (13), for different liquid paint components to be mixed with one another, the first chamber (11) having an outlet opening (14) and the second chamber (12) having an outlet opening (15). In the case of this embodiment, the paint reservoir (1) has a closable cover (6), by way of which compressed air can be applied through an opening (5). Furthermore, the particular embodiment of the device according to the invention as shown in FIG. 2 comprises a metering device (B or 2) with two inlet openings (21 and 22) for the components to be metered and to be mixed. As already described in detail above, the metering device is designed such that the volume flows of the paint components to be mixed with one another entering via the two inlet openings (21 and 22) are forcibly delivered separately from one another by way of rotating delivery devices serving as metering units. In this case, the delivery devices are connected to one another in such a way that their rotational speeds are in fixed ratios in relation to one another. The metered volume flows of the paint components are then supplied to the downstream static mixing device (C or 3) via the outlet openings (23 and 24). Here, the static mixing device has two inlet openings (31 and 32) and an outlet opening (4) for fastening the device to the paint spray gun. The static mixing device preferably comprises one or more so-called mixer rods (33). The mixer rods/elements may be fitted vertically, horizontally or in some other way, but they must provide adequately thorough mixing of the components.

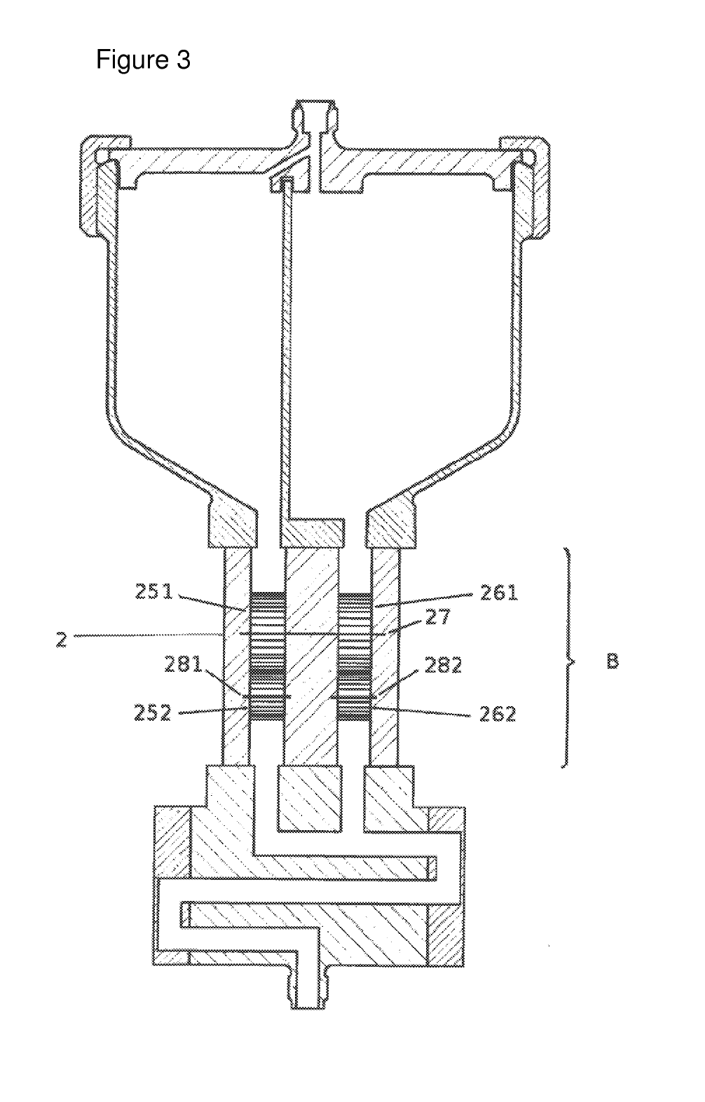

Described in more detail in FIG. 3 is an embodiment of a metering device (B or 2) in which each rotating delivery device has a pair of wheels (251/252 or 261/262) and at least one wheel (251) of the pair of wheels (251/252) is connected by way of a common spindle to the corresponding wheel (261) of the pair of wheels (261/262) located in the adjacent delivery device, so that their rotational speeds are in fixed ratios in relation to one another. The spindle (27) consequently enforces a synchronized rotation of the wheels 251 and 261, whereby forced delivery of the volume flows takes place. The second wheel of the two pairs of wheels in each case, that is wheel 252 with respect to wheel 251 or wheel 262 with respect to wheel 261, may be mounted on a spindle of its own (281 or 282). These second wheels (252, 262) are driven by the rotation of the first wheels (251, 261).

In any case, the materials of the three device units are chosen such that they are inert with respect to the paint components to be mixed and satisfy the mechanical requirements. Suitable for reasons of weight are particularly inert, abrasion-resistant plastics that are resistant to the paint components, such as solvents, hardeners etc., such as for example Teflon, polyoxymethylene, polyphenylene sulfide, polypropylene, polyamide, polyetherether ketone or polyarylether ketone. When flammable or explosive products are used, dissipative materials must be chosen to prevent electrostatic charging. In the case of plastics, dissipative plastics with a resistance of less than 10⁶ ohms must be used. However, the production of device units from metallic materials is also conceivable, though costly and less advantageous in the case of manual operation of the spray gun, particularly because of the greater weight.

In one particular design of the paint reservoir, the two or more chambers are separated from one another by separating walls (see FIG. 2). It is also possible, however, to realize the two or more chambers in such a way that they are placed into the paint reservoir in the form of bags or the like and the openings of the bags are connected to the outlet openings of the paint reservoir. In such a case, a separation by way of rigid separating walls, for example, is not necessary. The volumes of the chambers are advantageously chosen such that they correspond to the requirement for the components in the finished mixture.

Pairs of gear wheels, such as for example pairs of oval wheels, are obtainable, inter alia, from the company Bopp & Reuther under the trade name “Miniflow 015”. The desired ratio of the volume flows of the paint components is preferably set by way of adapting the widths of the gear wheels or oval wheels. The ratio of the volume flows of the paint components may, however, also be fixed by way of other parameters, such as the wheel diameter or, if coupling by way of a gear mechanism, rotational speed ratios. If bucket wheels are used, regulating the volume flows may also take place, for example, by way of the depth of the buckets.

In one particular design, the static mixing device consists of a mixing tube with fixed internals. Preferably, so-called mixer rods can be used. Most particularly preferred mixer rods are obtainable, for example, from the company Fluitec Georg AG (Neftenbach, Switzerland) under the name CSE-X® mixer.

In principle, all spray guns that are used for compressed-air spraying are suitable as spray guns. The use of the static mixing device with the spray gun is unproblematic and can take place with all commonly used connections, preferably by way of a screw thread or quick-action couplings or dovetail joints. Paint spray guns are obtainable, for example, from the company Sata GmbH & Co. KG (Kornwestheim, Germany) under the name SATAjet®, as HVLP or RP spray guns.

All components and materials are chosen by a person of average skill in the art such that they are designed for the pressures occurring.

In principle, the individual device units can also be externally heated. However, this is not usually provided.

An essential component part of the device according to the invention is a metering device, which has two or more inlet openings for components to be mixed, the metering device being designed such that the volume flows of the paint components to be mixed with one another entering via the inlet openings are forcibly delivered separately from one another by way of rotating delivery devices serving as metering units, the delivery devices being connected to one another in such a way that their rotational speeds are in fixed ratios in relation to one another, and the metering device having separate outlet openings for the then metered volume flows of the paint components. This metering device is also referred to as the metering device according to the invention.

The present invention also relates to a method for delivering, metering and mixing two or more paint components that makes use of the device according to the invention and/or the metering device according to the invention.

Furthermore, the present invention relates to a method for coating substrates with 2-component or multi-component coating agents using the device according to the invention in combination with a paint spray gun. Particularly advantageously, the coating method according to the invention is carried out purely manually. In particular, the coating method according to the invention is suitable when using small amounts of paint. The method is preferably carried out as an HVLP spraying method. Most particularly preferably, it is used for auto repair painting. The aforementioned method may, however, also be used in the course of OEM first-time painting, in particular for so-called assembly repair.

If the method is carried out as an HVLP spraying method, the atomizing pressure is usually 1.5 to 2 bar. In the case of RP guns, an atomizing pressure of 1.5 to 3 bar is usually used. To assist the delivery of the paint, compressed air may be applied to the paint reservoir or paint reservoirs; the positive pressure can be set in dependence on the the viscosity of the paint and the run-out rate.

If two components are used, one component is usually the so-called base paint, the second component is the hardener. Preferably used in the base paints are hydroxyfunctional polymers, such as for example polyhydroxyfunctional poly(meth)acrylates, polyester polyols, polyether polyols, polyurethane polyols or mixed polyester/polyether polyols. Polythiols can also be used for example. Usually used in the hardener components are polyisocyanates, such as hexamethylene diisocyanate, toluene diisocyanate, isophorone diisocyanate or diphenylmethane diisocyanate, or the dimers, trimers and polymers of the aforementioned isocyanates and/or aminoplastic resins, such as for example melamine resins. Epoxy systems, both conventional and aqueous, can likewise be used. It goes without saying that those systems that only become reactive when they come together with atmospheric moisture (for example aldimines, silanes) may also be used. However, it applies in general that the base paint and the hardener comprise compounds with functional groups that are complementary to one another. That is to say groups which react with one another after the mixing of the two components. For example, the following complementary groups may be mentioned: amine/isocyanate, hydroxy/isocyanate, thiol/isocyanate, amine/epoxy resin/isocyanate, amine/epoxy resin, epoxy resin/anhydride, amine/anhydride, anhydride/hydroxy or hydroxy/isocyanate/amine groups. The base paint and the hardener usually react after application at temperatures from 0 to 100° C., preferably 10 to 80° C., that is to say under usual conditions for repair painting.

Those combinations of base paint and hardener that have pot lives that are too short for the usual procedure of premixing the components before filling the paint reservoir can also be chosen in the method according to the invention. Even with such systems, outstanding coatings are obtained, distinguished by short drying and hardening times and an outstanding appearance.

The invention will be explained on the basis of examples.

### EXAMPLES

It is found that conventionally manually metered and mixed paint compositions have poorer drying characteristics after compressed-air spraying than those that have been prepared with the device according to the invention and sprayed directly thereafter. The drying was measured by means of a so-called Drying Recorder (type B.K. from the company The Mickle Laboratory Engineering Co, Ltd. GB). For the assessment, strips of glass were painted in two spraying operations (resultant dry layer thickness 30-40 μm) with a Sata RP 1.3 NR gun. A solvent evaporation time of 1 min was allowed between the spraying operations. Subsequently, the Stage IV Dry Through Time was determined over a test period of 12 h at 22° C. and a relative atmospheric humidity of 45% by analogy with ASTM D 5895. The results can be seen from Table 1.

TABLE 1

| | | | method according to | |
|---|---|---|---|---|
| | conventional method | | the invention | |
| | | Paint + 0.5% | | Paint + 0.5% |
| | Paint | cat. | Paint | cat. |
| Stage IV | 8.5 | 6.5 | 7.5 | 1.5 |
| Dry Through | | | | |
| Time in h | | | | |

The paint used consists of Glasurit clearcoat 923-335 (BASF Coatings GmbH), which has been mixed in a volumetric mixing ratio of 2:1 with the hardener 929-33 (BASF Coatings GmbH) and processed with 10% by volume thinner 352-91. A mixture of 45 g butyl acetate, 45 g xylene and 10 g DBTL (dibutyltin dilaurate) was used as the catalyst solution.

1. A device for delivering, metering and mixing liquid paint components, comprising:
(a) a paint supplying device, which
i. comprises two or more paint reservoirs with in each case at least one outlet opening for different paint components to be mixed with one another; or
ii. comprises one paint reservoir, which comprises two or more chambers for different paint components to be mixed with one another, each chamber having at least one outlet opening,
(b) a metering device, which is arranged downstream of the paint supplying device and has a number of inlet openings for the paint components corresponding to the number of outlet openings of the paint reservoirs or the paint reservoir, the metering device being designed such that the volume flows of the paint components to be mixed with one another entering via the inlet openings are forcibly delivered separately from one another by way of rotating delivery devices without external driving serving as metering units, the delivery devices being connected to one another in such a way that their rotational speeds are in fixed ratios in relation to one another, and the metering device having separate outlet openings for the then metered volume flows of the paint components, and
(c) a static mixing device, which is arranged downstream of the metering device and has a number of inlet openings for the metered volume flows corresponding to the number of outlet openings of the metering device, and the outlet of which is formed in such a way that it can be connected to a paint spray gun;
wherein each rotating delivery device has a pair of wheels and at least one wheel of the pair of wheels is connected by way of a common spindle to the corresponding wheel of the pair of wheels located in the adjacent delivery device, so that their rotational speeds are in fixed ratios in relation to one another and the wheels of the pairs of wheels being oval wheels.

2. The device according to claim 1 comprising:
one paint reservoir, which includes (a) two chambers for different paint components to be mixed with one another, each chamber having at least one outlet opening, (b) a metering device, which is arranged downstream of the paint reservoir and has two inlet openings for the paint components.

3. (canceled)

4. (canceled)

5. The device according to claim 1, wherein at least one of the paint reservoirs has a closable cover, by way of which compressed air can be applied.

6. A method for delivering, metering and mixing two or more paint components comprising loading the two or more paint components into the device of 1; and connecting the paint spray gun to the device of claim 1 to deliver, meter, and mix the two or more paint components.

7. A method for coating substances with two- or multi-component coating agents comprising connecting the paint spray gun to the device of claim 1, delivering a base paint and a hardener into the static mixing device by way of the paint reservoir and the metering device, forming a homogeneous mixture of base paint and hardener from the static mixing device, and supplying the homogenous mixture to the spray gun, and applying the homogenous mixture to the substrate by way of the spray gun.

8. A metering device, which has two or more inlet openings for components to be mixed, the metering device being designed such that the volume flows of the paint components to be mixed with one another entering via the inlet openings are forcibly delivered separately from one another by way of rotating delivery devices without external driving serving as metering units, the delivery devices being connected to one another in such a way that their rotational speeds are in fixed ratios in relation to one another, and the metering device having separate outlet openings for the then metered volume flows of the paint components, wherein each rotating delivery device has a pair of wheels and at least one wheel of the pair of wheels is connected by way of a common spindle to the corresponding wheel of the pair of wheels located in the adjacent delivery device, so that their rotational speeds are in fixed ratios in relation to one another and the wheels of the pairs of wheels being oval wheels.

9. (canceled)

10. A method for the synchronized metering of at least two separate volume flows comprising supplying the at least two separate volume flows to the metering device according to claim 8 and forming a synchronized flow after the metering.
